(19) United States
(12) Patent Application Publication
(10) Pub. No.: US 2025/0219312 A1
(43) Pub. Date: Jul. 3, 2025

(54) ELECTRICAL CONNECTOR

(71) Applicant: LOTES CO, LTD., Keelung (TW)

(72) Inventor: Zhi-Yong Zhou, Keelung (TW)

(21) Appl. No.: 18/965,024

(22) Filed: Dec. 2, 2024

(30) Foreign Application Priority Data
Dec. 29, 2023 (CN) 202311871050.2

(51) Int. Cl. H01R 13/24; H01R 12/55; H01R 13/514; H01R 13/629; H01R 13/64

(52) U.S. Cl. CPC H01R 13/2407; H01R 13/514; H01R 13/629; H01R 13/64; H01R 12/55

(57) ABSTRACT

An electrical connector has multiple accommodating slots surrounded by a front wall, a rear wall and two side walls. A stopping block protrudes from each side wall. Each side wall has a stopping surface located behind the stopping block and a concave surface located in front of the stopping block. The rear wall has an abutting surface. In two adjacent accommodating slots in the left-right direction, a distance between two adjacent stopping surfaces is a first distance, and a distance between two adjacent concave surfaces is a second distance. In two adjacent accommodating slots in the front-rear direction, a distance between the abutting surface of a front accommodating slot and the front wall of a rear accommodating slot is a third distance. A ratio of the second distance and the first distance and a ratio of the third distance and the first distance are both between 0.8 and 1.5.

### CROSS-REFERENCE TO RELATED PATENT APPLICATION

This non-provisional application claims priority to and the benefit of, pursuant to 35 U.S.C. § 119(a), patent application Serial No. CN202311871050.2 filed in China on Dec. 29, 2023. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and particularly to an electrical connector reducing cracks in the plastic body.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An existing electrical connector includes a plastic body and a plurality of terminals. The plastic body has a plurality of accommodating slots in a plurality of rows and running therethrough, and the accommodating slots in each row are arranged along a left-right direction. The terminals are correspondingly accommodated in the accommodating slots. Each terminal has a main body portion and an elastic arm bending and extending from an upper end of the main body portion. The elastic arm is used to abut upward against a mating component. Each accommodating slot includes a first slot limiting the main body portion and a second slot having a shorter width in the left-right direction than the first slot. The second slot is located in front of the first slot, and the two slots are in communication with each other. The plastic body is provided with a first partition between two adjacent first slots in the left-right direction and a second partition between two adjacent second slots in the left-right direction, and along the left-right direction, a width of the first partition is less than a width of the second partition, thus resulting in the combining line during the forming of the plastic body being located on the first partition. After the electrical connector is soldered to the circuit board, due to the thermal expansion and contraction and the weaker strength of the first partition, cracks appear on the first partition, thus affecting the positioning of each terminal in the corresponding accommodating slot, and thereby affecting the normal usage of the electrical connector.

Therefore, a heretofore unaddressed need to design a new electrical connector exists in the art to address the aforementioned deficiencies and inadequacies.

### SUMMARY

The present invention is directed to an electrical connector reducing cracks in the plastic body.

To achieve the foregoing objective, the present invention adopts the following technical solutions.

An electrical connector includes: a plurality of terminals in a plurality of rows, wherein each of the terminals comprises a main body portion and an elastic arm bending and extending from an upper end of the main body portion, and the elastic arm has a contact portion located in front of the main body portion to abut upward against a mating component; and a plastic body, having an upper surface, a lower surface opposite to the upper surface, and a plurality of accommodating slots in a plurality of rows running through the upper surface and the lower surface to accommodate the corresponding terminals, wherein the accommodating slots in each of the rows are arranged along a left-right direction, and each of the accommodating slots is surrounded by a front wall and a rear wall opposite to each other in a front-rear direction and two side walls opposite to each other in the left-right direction; wherein a stopping block protrudes from each of the side walls, the stopping block stops the main body portion of a corresponding terminal of the terminals from moving forward, each of the side walls has a stopping surface located behind the stopping block and a concave surface located in front of the stopping block, the stopping block protrudes out of the stopping surface and the concave surface, the stopping surface stops the main body portion of the corresponding terminal along the left-right direction, and the concave surface is connected to the upper surface, the stopping block and the front wall; wherein the rear wall has an abutting surface for the main body portion to abut backward against the abutting surface; wherein a distance between two adjacent stopping surfaces of two adjacent ones of the accommodating slots in the left-right direction is defined as a first distance, a distance between two adjacent concave surfaces of the two adjacent ones of the accommodating slots in the left-right direction is defined as a second distance, a distance between the abutting surface of a front accommodating slot of two adjacent ones of the accommodating slots in the front-rear direction and the front wall of a rear accommodating slot of the two adjacent ones of the accommodating slots in the front-rear direction is defined as a third distance, a ratio of the second distance and the first distance is between 0.8 and 1.5, and a ratio of the third distance and the first distance is between 0.8 and 1.5.

In certain embodiments, a connecting location of the stopping block and the concave surface on the upper surface is in a curve shape.

In certain embodiments, a pair of clamping legs extend downward from the main body portion to clamp a left side and a right side of a solder ball, and the main body portion and the clamping legs are located on a same plane; a connecting block protrudes backward from the front wall, a first position limiting block is formed by extending downward from the connecting block, the first position limiting block has a top surface, the connecting block has a bottom surface and an oblique surface extending obliquely upward from the bottom surface such that a width of the connecting block gradually become shorter upward from bottom thereof, the bottom surface is connected to the top surface, and the top surface protrudes out of the bottom surface leftward, rightward and forward respectively; a second position limiting block protrudes downward from the lower surface behind each of the solder ball, and the solder ball is limited by the first position limiting block and the second position limiting block from moving in the front-rear direction.

In certain embodiments, the accommodating slots in two adjacent rows in a front-rear direction are staggered, a third position limiting block protrudes from the lower surface behind the clamping legs and a fourth position limiting block protrudes from the lower surface in front of the clamping legs, the third position limiting block is connected to the first position limiting block, and the fourth position limiting block is connected to the stopping block and the second position limiting block.

In certain embodiments, each of a left side and a right side of the main body portion is protrudingly provided with an interference portion to be in interference fit with the corresponding stopping surface, and the elastic arm extends forward from an upper end of the main body portion and is located in front of the main body portion.

The present invention further adopts the following technical solutions.

An electrical connector includes: a plurality of terminals, wherein each of the terminals comprises a main body portion and an elastic arm bending and extending from an upper end of the main body portion, and the elastic arm has a contact portion located in front of the main body portion to abut upward against a mating component; and a plastic body, having an upper surface, a lower surface opposite to the upper surface, and a plurality of accommodating slots in a plurality of rows running through the upper surface and the lower surface to accommodate the corresponding terminals, wherein the accommodating slots in each of the rows are arranged along a left-right direction, the accommodating slots in two adjacent rows in a front-rear direction are staggered, each of the accommodating slots is surrounded by a front wall and a rear wall opposite to each other in a front-rear direction and two side walls opposite to each other in the left-right direction, and a plurality of supporting blocks protrude upward from the upper surface to support the mating component upward; wherein a stopping block protrudes from each of the side walls, the stopping block stops the main body portion of a corresponding terminal of the terminals from moving forward, each of the side walls has a stopping surface located behind the stopping block and a concave surface located in front of the stopping block, the stopping block protrudes out of the stopping surface and the concave surface, the stopping surface stops the main body portion of the corresponding terminal along the left-right direction, and the concave surface is connected to the stopping block, the front wall and the upper surface; wherein the rear wall has a guiding surface extending obliquely downward from the upper surface and an abutting surface extending downward from the guiding surface, and the abutting surface is configured for the main body portion to abut backward against the abutting surface; wherein for two adjacent ones of the accommodating slots in the front-rear direction, the supporting block is connected to the front wall and the concave surface of a rear accommodating slot of the two adjacent ones of the accommodating slots and the guiding surface of a front accommodating slot of the two adjacent ones of the accommodating slots.

In certain embodiments, a pair of clamping legs extend downward from the main body portion to clamp a left side and a right side of a solder ball, and the main body portion and the clamping legs are located on a same plane; a connecting block protrudes backward from the front wall, a first position limiting block is formed by extending downward from the connecting block, the first position limiting block has a top surface, the connecting block has a bottom surface and an oblique surface extending obliquely upward from the bottom surface such that a width of the connecting block gradually become shorter upward from bottom thereof, the bottom surface is connected to the top surface, and the top surface protrudes out of the bottom surface leftward, rightward and forward respectively; a second position limiting block protrudes downward from the lower surface behind each of the solder ball, and the solder ball is limited by the first position limiting block and the second position limiting block from moving in the front-rear direction.

In certain embodiments, the accommodating slots in two adjacent rows in a front-rear direction are staggered, a third position limiting block protrudes from the lower surface behind the clamping legs and a fourth position limiting block protrudes from the lower surface in front of the clamping legs, the third position limiting block is connected to the first position limiting block, and the fourth position limiting block is connected to the stopping block and the second position limiting block.

In certain embodiments, a connecting location of the stopping block and the concave surface on the upper surface is in a curve shape.

The present invention further adopts the following technical solutions.

An electrical connector includes: a plurality of terminals, wherein each of the terminals comprises a main body portion and an elastic arm bending and extending from an upper end of the main body portion, the elastic arm has a contact portion located in front of the main body portion to abut upward against a mating component; one side of a left side and a right side of the main body portion is provided with a first strip connecting edge and a notch recessed from the first strip connecting edge, the notch is located above the first strip connecting edge; a connecting location of the elastic arm and the main body portion has a first side edge, and the notch is recessed relative to the first side edge and is connected to the first side edge; and a plastic body, having an upper surface, a lower surface opposite to the upper surface, and a plurality of accommodating slots running through the upper surface and the lower surface to accommodate the corresponding terminals.

In certain embodiments, the other side of the left side and the right side of the main body portion is provided with a second strip connecting edge, an upper edge of the second strip connecting edge is higher than an upper edge of the first strip connecting edge; the elastic arm has a second side edge opposite to the first side edge in the left-right direction, the upper end of the main body portion has an exposed region, the exposed region protrudes out of the second side edge along the left-right direction, and the second strip connecting edge is connected to the exposed region.

In certain embodiments, a pair of clamping legs extend downward from the main body portion to clamp a left side and a right side of a solder ball, and the main body portion and the clamping legs are located on a same plane; each of the accommodating slots has a front wall, a connecting block protrudes backward from the front wall, a first position limiting block is formed by extending downward from the connecting block, the first position limiting block has a top surface, the connecting block has a bottom surface and an oblique surface extending obliquely upward from the bottom surface such that a width of the connecting block gradually become shorter upward from bottom thereof, the bottom surface is connected to the top surface, and the top surface protrudes out of the bottom surface leftward, rightward and forward respectively; a second position limiting block protrudes downward from the lower surface behind each of the solder ball, and the solder ball is limited by the first position limiting block and the second position limiting block from moving in the front-rear direction.

In certain embodiments, the accommodating slots in two adjacent rows in a front-rear direction are staggered, a third position limiting block protrudes from the lower surface behind the clamping legs and a fourth position limiting block protrudes from the lower surface in front of the clamping legs, the third position limiting block is connected to the first position limiting block, and the fourth position limiting block is connected to the stopping block and the second position limiting block.

Compared to the related art, the electrical connector according to certain embodiments of the present invention has the following beneficial effects:

By providing the ratio of the second distance and the first distance to be between 0.8 and 1.5 and providing the ratio of the third distance and the first distance to be between 0.8 and 1.5, the combining line of forming the plastic body avoids the location between two adjacent stopping surfaces with the weaker strength and is located at the stopping block with the higher strength, thus reducing the issue of generating cracks on the two side walls of each accommodating slot after the electrical connector is soldered to the circuit board.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective schematic view of an electrical connector and a mating component according to certain embodiments of the present invention.

FIG. 2 is a perspective exploded view of the electrical connector in FIG. 1.

FIG. 3 is a partial top view of a plastic body of the electrical connector in FIG. 2.

FIG. 4 is a partial plain sectional view of the electrical connector in FIG. 2 sectioned along a Y-Z plane.

FIG. 5 is a partial perspective sectional view of the electrical connector in FIG. 2 sectioned along a X-Z plane.

FIG. 6 is a partial perspective schematic view of the electrical connector in FIG. 2 in another viewing angle.

FIG. 7 is a schematic view of the terminal connected to the strip in FIG. 2.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

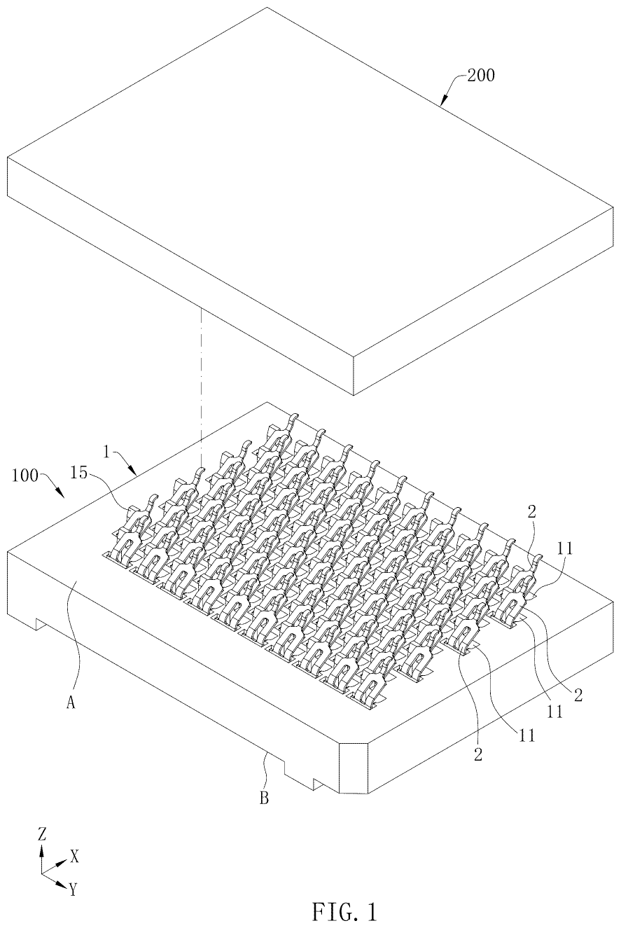

The description will be made as to the embodiments of the present invention in conjunction with the accompanying drawings in FIGS. 1-7. In accordance with the purposes of this invention, as embodied and broadly described herein, this invention, in one aspect, relates to an electrical connector.

For convenience of understanding, a front-rear direction is represented by X, in which the forward direction is the positive direction of the X-axis; a left-right direction is represented by Y, in which the rightward direction is the positive direction of the Y-axis; and a vertical direction is represented by Z, in which the upward direction is the positive direction of the Z-axis. Any two of the front-rear direction X, the left-right direction Y and the vertical direction Z are perpendicular to each other.

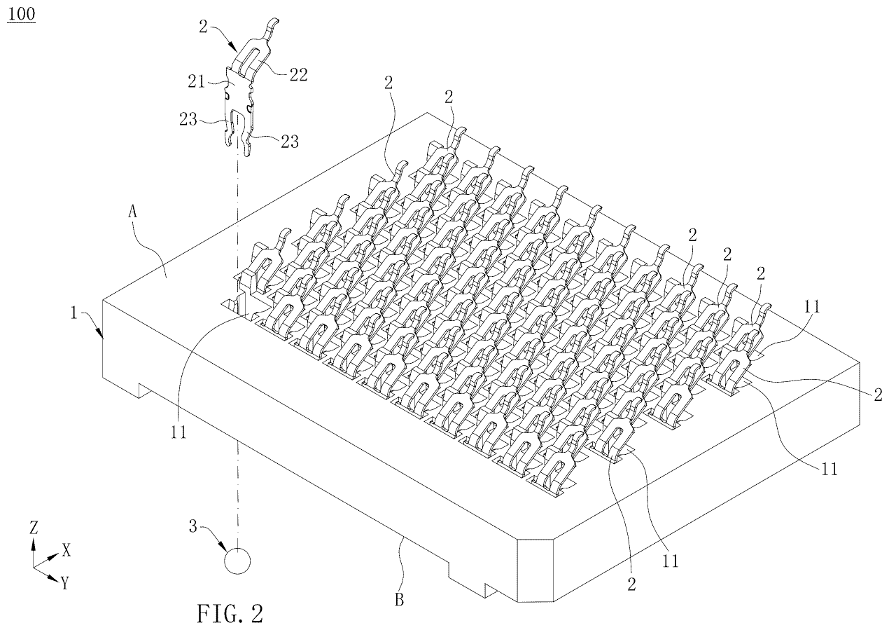

As shown in FIG. 1 and FIG. 2, the electrical connector 100 is used to electrically connect a mating component 200 and a circuit board, and includes a plastic body 1 and a plurality of terminals 2 accommodated in the plastic body 1.

As shown in FIG. 1 and FIG. 2, the plastic body 1 has an upper surface A, a lower surface B opposite to the upper surface A, and a plurality of accommodating slots 11 in a plurality of rows running through the upper surface A and the lower surface B. The accommodating slots 11 in each row are arranged along the left-right direction. The accommodating slots 11 in two adjacent rows in the front-rear direction are staggered. Each accommodating slot 11 is surrounded by a front wall 12 and a rear wall 13 opposite to each other in the front-rear direction and two side walls 14 opposite to each other in the left-right direction.

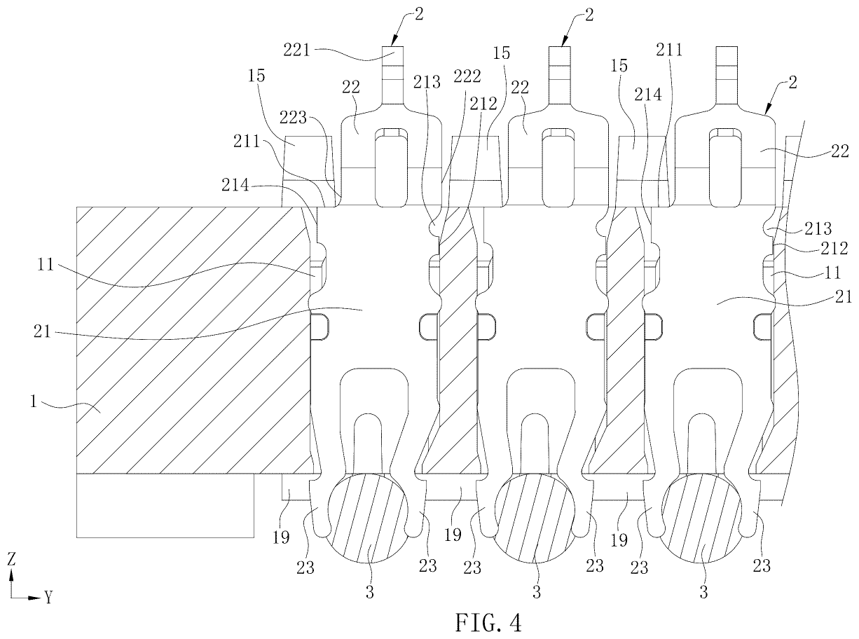

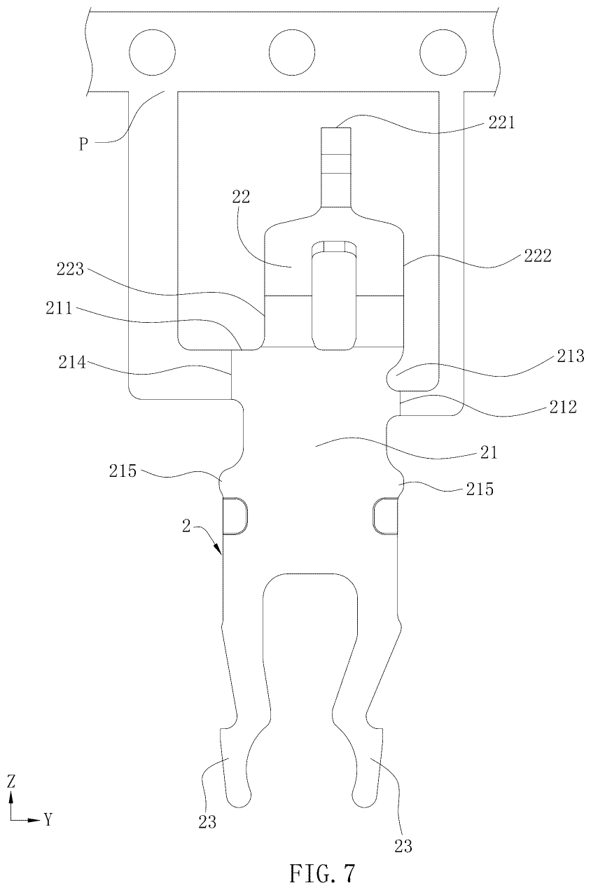

As shown in FIG. 2, FIG. 4 and FIG. 7, the terminals 2 are correspondingly accommodated in the accommodating slots 11. Each terminal includes a main body portion 21, an elastic arm 22 bending and extending from an upper end of the main body portion 21, and a pair of clamping legs 23 extending downward from the main body portion 21 and located on a same plane as the main body portion 21. In the present embodiment, the elastic arm 22 extends forward from the upper end of the main body portion and is located in front of the main body portion 21. (In other embodiments, the elastic arm 22 may firstly extend backward and then extend forward from the upper end of the main body portion 21.) The elastic arm 22 has a contact portion 221 to abut upward against the mating component 200, and the contact portion 221 is located in front of the main body portion 21. For a connecting location of the elastic arm 22 and the main body portion 21, its right side has a first side edge 222, and its left side has a second side edge 223 opposite to the first side edge 222 in the left-right direction. The main body portion 21 is used to position with the corresponding accommodating slot 11. The upper end of the main body portion 21 has an exposed region 221 protruding leftward out of the second side edge 223. The right side of the main body portion 21 is provided with a first strip connecting edge 212 and a notch 213 recessed from the first strip connecting edge 212 and located above the first strip connecting edge 212. The left side of the main body portion 21 is provided with a second strip connecting edge 214, and the second strip connecting edge 214 is connected to the exposed region 211. During the forming of the terminals 2, a strip P is connected to the first strip connecting edge 212 and the second strip connecting edge 214. Before inserting the terminals 2 into the corresponding accommodating slots 11, the strip P and the terminals 2 are separated from each other. The left side and the right side of the main body portion 21 are protrudingly provided with interference portions 215 corresponding to be below the first strip connecting edge 212 and the second strip connecting edge 214, respectively. In the present embodiment, the left side of the upper end of the main body portion 21 protrudes out of the elastic arm 22 and the right side thereof does not protrude out of the elastic arm 22. Thus, the first strip connecting edge 212 is provided at the right side of the main body portion 21, and the second strip connecting edge 214 is provided at the left side of the main body portion 21. In other embodiments, it is possible that the right side of the upper end of the main body portion 21 protrudes out of the elastic arm 22 and the left side thereof does not protrude out of the elastic arm 22. In this case, the first strip connecting edge 212 is provided at the left side of the main body portion 21, and the second strip connecting edge 214 is provided at the right side of the main body portion 21. The notch 213 is recessed relative to the first side edge 222 and is connected to the first side edge 222. An upper edge of the second strip connecting edge 214 is higher than an upper edge of the first strip connecting edge 212. By providing the upper edge of the first strip connecting edge 212 to be lower than the upper edge of the second strip connecting edge 214, the notch 213 may be prevented from being provided on the elastic arm 22 and affecting the elastic characteristics of the elastic arm 22. The pair of clamping legs 23 is used to clamp a left side and a right side of a solder ball 3. In other embodiments, the terminals 2 are not limited to being soldered to the circuit board by solder balls 3. For example, the terminals 2 may elastically abut against the circuit board downward or be inserted into the circuit board.

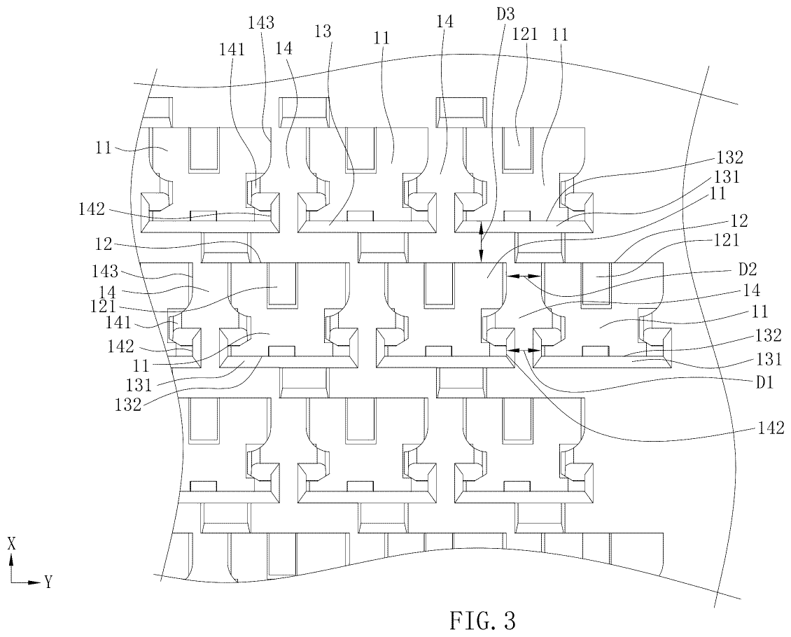

As shown in FIG. 3, a stopping block 141 protrudes from each side wall 14, and the stopping block 141 stops the main body portion 21 of the corresponding terminal 2 of the terminals from moving forward. Each side wall 14 has a stopping surface 142 located behind the stopping block 141 and a concave surface 143 located in front of the stopping block 141. The stopping block 141 protrudes out of the stopping surface 142 and the concave surface 143, and a connecting location of the stopping block 141 and the concave surface 143 on the upper surface A is in a curve shape. The stopping surface 142 stops the corresponding main body portion 21 along the left-right direction (in the present embodiment, the interference portion 215 is in interference fit with the stopping surface 142, and in other embodiments, it is possible that the main body portion 21 and the stopping surface 142 are not in intereference fit), and the concave surface 143 is connected to the upper surface A, the stopping block 141 and the front wall 12. The rear wall 13 has a guiding surface 131 extending obliquely downward from the upper surface A and an abutting surface 132 extending downward from the guiding surface 131, and the abutting surface 132 is used for the main body portion 21 to abut backward against the abutting surface 132. A distance between two adjacent stopping surfaces 142 of two adjacent accommodating slots 11 in the left-right direction is defined as a first distance D1, a distance between two adjacent concave surfaces 143 of the two adjacent accommodating slots 11 in the left-right direction is defined as a second distance D2, and a distance between the abutting surface 132 of a front accommodating slot 11 of two adjacent accommodating slots 11 in the front-rear direction and the front wall 12 of a rear accommodating slot 11 of the two adjacent accommodating slots 11 in the front-rear direction is defined as a third distance D3. A ratio of the second distance D2 and the first distance D1 is between 0.8 and 1.5, and a ratio of the third distance D3 and the first distance D1 is between 0.8 and 1.5. By providing the concave surface 143 on each side wall 14, the combining line on the side walls 14 when the plastic body 1 is formed is located on the stopping block 141, and the stopping block 141 has a higher strength. When the electrical connector 100 is soldered to the circuit board, the side walls 14 of each accommodating slot 11 does not easily generate cracks.

As shown in FIG. 3 and FIG. 4, the plastic body 1 has a plurality of supporting blocks 15 protruding upward from the upper surface A to support the mating component 200. For two adjacent accommodating slots 11 in the front-rear direction, the supporting block 15 is connected to the front wall 12 and the concave surface 143 of the left side wall 14 of the rear accommodating slot 11 and the guiding surface 131 of the front accommodating slot 11. (In other embodiments, .it is also possible that the supporting block 15 is connected to the front wall 12 and the concave surface 143 of the right side wall 14 of the rear accommodating slot 11 and the guiding surface 131 of the front accommodating slot 11.)

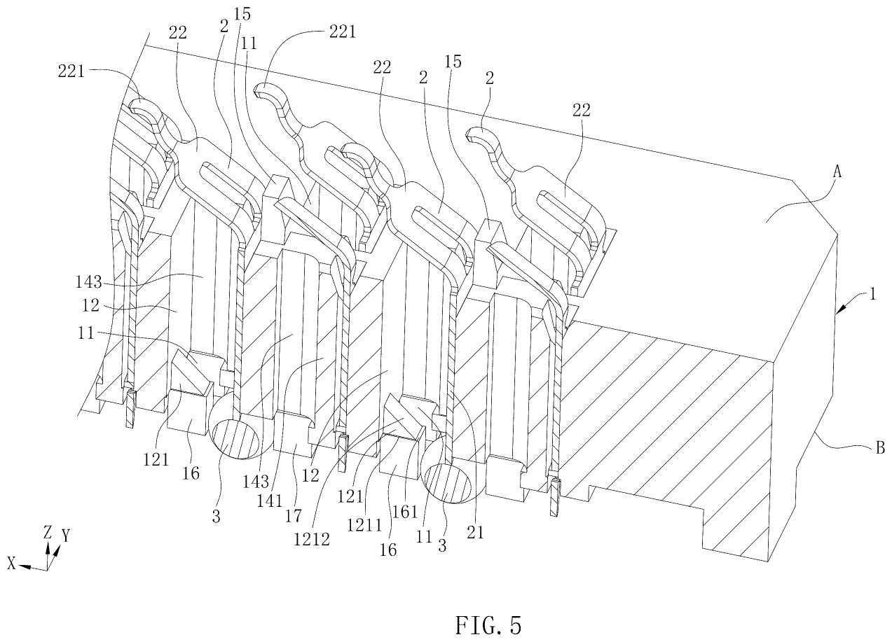

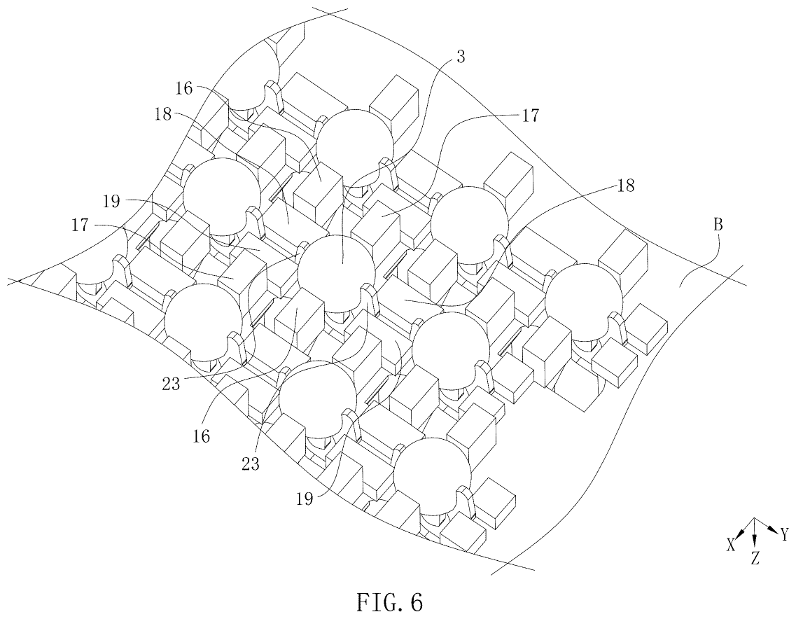

As shown in FIG. 5 and FIG. 6, a connecting block 121 protrudes backward from the front wall 12. A first position limiting block 16 is formed by extending downward from the connecting block 121, and the first position limiting block 16 has a top surface 161. The connecting block 121 has a bottom surface 1211 and an oblique surface 1212 extending obliquely upward from the bottom surface 1211 such that a width of the connecting block 121 gradually become shorter upward from bottom thereof. The bottom surface 1211 of the connecting block 121 is connected to the top surface 161 of the first position limiting block 16. The top surface 161 protrudes out of the bottom surface 1211 leftward, rightward and forward respectively. A second position limiting block 17 protrudes downward from the lower surface B behind each solder ball 3, and the solder ball 3 is limited by the first position limiting block 16 and the second position limiting block 17 from moving in the front-rear direction.

As shown in FIG. 6, a third position limiting block 18 protrudes from the lower surface B behind the clamping legs 23 and a fourth position limiting block 19 protrudes from the lower surface B in front of the clamping legs 23. The third position limiting block 18 is connected to the corresponding first position limiting block 16, and the fourth position limiting block 19 is connected to the corresponding stopping block 141 and the second position limiting block 17.

In sum, the electrical connector 100 according to certain embodiments of the present invention has the following beneficial effects:
(1) By providing the ratio of the second distance D2 and the first distance D1 to be between 0.8 and 1.5 and providing the ratio of the third distance D3 and the first distance D1 to be between 0.8 and 1.5, the combining line of forming the plastic body 1 avoids the location between two adjacent stopping surfaces 142 with the weaker strength and is substantially located at the stopping block 141 with the higher strength, thus reducing the issue of generating cracks on the side walls 14 after the electrical connector 100 is soldered to the circuit board.
(2) The connecting location of the stopping block 141 and the concave surface 143 on the upper surface A is in a curve shape, thus improving the flow of the plastic during the forming process of the plastic body 1, and improving the strength of the stopping block 141.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
a plurality of terminals in a plurality of rows, wherein each of the terminals comprises a main body portion and an elastic arm bending and extending from an upper end of the main body portion, and the elastic arm has a contact portion located in front of the main body portion to abut upward against a mating component; and
a plastic body, having an upper surface, a lower surface opposite to the upper surface, and a plurality of accommodating slots in a plurality of rows running through the upper surface and the lower surface to accommodate the corresponding terminals, wherein the accommodating slots in each of the rows are arranged along a left-right direction, and each of the accommodating slots is surrounded by a front wall and a rear wall opposite to each other in a front-rear direction and two side walls opposite to each other in the left-right direction;
wherein a stopping block protrudes from each of the side walls, the stopping block stops the main body portion of a corresponding terminal of the terminals from moving forward, each of the side walls has a stopping surface located behind the stopping block and a concave surface located in front of the stopping block, the stopping block protrudes out of the stopping surface and the concave surface, the stopping surface stops the main body portion of the corresponding terminal along the left-right direction, and the concave surface is connected to the upper surface, the stopping block and the front wall;
wherein the rear wall has an abutting surface for the main body portion to abut backward against the abutting surface;
wherein a distance between two adjacent stopping surfaces of two adjacent ones of the accommodating slots in the left-right direction is defined as a first distance, a distance between two adjacent concave surfaces of the two adjacent ones of the accommodating slots in the left-right direction is defined as a second distance, a distance between the abutting surface of a front accommodating slot of two adjacent ones of the accommodating slots in the front-rear direction and the front wall of a rear accommodating slot of the two adjacent ones of the accommodating slots in the front-rear direction is defined as a third distance, a ratio of the second distance and the first distance is between 0.8 and 1.5, and a ratio of the third distance and the first distance is between 0.8 and 1.5.

2. The electrical connector according to claim 1, wherein a connecting location of the stopping block and the concave surface on the upper surface is in a curve shape.

3. The electrical connector according to claim 1, wherein a pair of clamping legs extend downward from the main body portion to clamp a left side and a right side of a solder ball, and the main body portion and the clamping legs are located on a same plane; a connecting block protrudes backward from the front wall, a first position limiting block is formed by extending downward from the connecting block, the first position limiting block has a top surface, the connecting block has a bottom surface and an oblique surface extending obliquely upward from the bottom surface such that a width of the connecting block gradually become shorter upward from bottom thereof, the bottom surface is connected to the top surface, and the top surface protrudes out of the bottom surface leftward, rightward and forward respectively; a second position limiting block protrudes downward from the lower surface behind each of the solder ball, and the solder ball is limited by the first position limiting block and the second position limiting block from moving in the front-rear direction.

4. The electrical connector according to claim 3, wherein the accommodating slots in two adjacent rows in a front-rear direction are staggered, a third position limiting block protrudes from the lower surface behind the clamping legs and a fourth position limiting block protrudes from the lower surface in front of the clamping legs, the third position limiting block is connected to the first position limiting block, and the fourth position limiting block is connected to the stopping block and the second position limiting block.

5. The electrical connector according to claim 1, wherein each of a left side and a right side of the main body portion is protrudingly provided with an interference portion to be in interference fit with the corresponding stopping surface, and the elastic arm extends forward from an upper end of the main body portion and is located in front of the main body portion.

6. An electrical connector, comprising:
a plurality of terminals, wherein each of the terminals comprises a main body portion and an elastic arm bending and extending from an upper end of the main body portion, and the elastic arm has a contact portion located in front of the main body portion to abut upward against a mating component; and
a plastic body, having an upper surface, a lower surface opposite to the upper surface, and a plurality of accommodating slots in a plurality of rows running through the upper surface and the lower surface to accommodate the corresponding terminals, wherein the accommodating slots in each of the rows are arranged along a left-right direction, the accommodating slots in two adjacent rows in a front-rear direction are staggered, each of the accommodating slots is surrounded by a front wall and a rear wall opposite to each other in a front-rear direction and two side walls opposite to each other in the left-right direction, and a plurality of supporting blocks protrude upward from the upper surface to support the mating component upward;
wherein a stopping block protrudes from each of the side walls, the stopping block stops the main body portion of a corresponding terminal of the terminals from moving forward, each of the side walls has a stopping surface located behind the stopping block and a concave surface located in front of the stopping block, the stopping block protrudes out of the stopping surface and the concave surface, the stopping surface stops the main body portion of the corresponding terminal along the left-right direction, and the concave surface is connected to the stopping block, the front wall and the upper surface;
wherein the rear wall has a guiding surface extending obliquely downward from the upper surface and an abutting surface extending downward from the guiding surface, and the abutting surface is configured for the main body portion to abut backward against the abutting surface;
wherein for two adjacent ones of the accommodating slots in the front-rear direction, the supporting block is connected to the front wall and the concave surface of a rear accommodating slot of the two adjacent ones of the accommodating slots and the guiding surface of a front accommodating slot of the two adjacent ones of the accommodating slots.

7. The electrical connector according to claim 6, wherein a pair of clamping legs extend downward from the main body portion to clamp a left side and a right side of a solder ball, and the main body portion and the clamping legs are located on a same plane; a connecting block protrudes backward from the front wall, a first position limiting block is formed by extending downward from the connecting block, the first position limiting block has a top surface, the connecting block has a bottom surface and an oblique surface extending obliquely upward from the bottom surface such that a width of the connecting block gradually become shorter upward from bottom thereof, the bottom surface is connected to the top surface, and the top surface protrudes out of the bottom surface leftward, rightward and forward respectively; a second position limiting block protrudes downward from the lower surface behind each of the solder ball, and the solder ball is limited by the first position limiting block and the second position limiting block from moving in the front-rear direction.

8. The electrical connector according to claim 7, wherein the accommodating slots in two adjacent rows in a front-rear direction are staggered, a third position limiting block protrudes from the lower surface behind the clamping legs and a fourth position limiting block protrudes from the lower surface in front of the clamping legs, the third position limiting block is connected to the first position limiting block, and the fourth position limiting block is connected to the stopping block and the second position limiting block.

9. The electrical connector according to claim 6, wherein a connecting location of the stopping block and the concave surface on the upper surface is in a curve shape.

10. An electrical connector, comprising:
a plurality of terminals, wherein each of the terminals comprises a main body portion and an elastic arm bending and extending from an upper end of the main body portion, the elastic arm has a contact portion located in front of the main body portion to abut upward against a mating component; one side of a left side and a right side of the main body portion is provided with a first strip connecting edge and a notch recessed from the first strip connecting edge, the notch is located above the first strip connecting edge; a connecting location of the elastic arm and the main body portion has a first side edge, and the notch is recessed relative to the first side edge and is connected to the first side edge; and
a plastic body, having an upper surface, a lower surface opposite to the upper surface, and a plurality of accommodating slots running through the upper surface and the lower surface to accommodate the corresponding terminals.

11. The electrical connector according to claim 10, wherein the other side of the left side and the right side of the main body portion is provided with a second strip connecting edge, an upper edge of the second strip connecting edge is higher than an upper edge of the first strip connecting edge; the elastic arm has a second side edge opposite to the first side edge in the left-right direction, the upper end of the main body portion has an exposed region, the exposed region protrudes out of the second side edge along the left-right direction, and the second strip connecting edge is connected to the exposed region.

12. The electrical connector according to claim 10, wherein a pair of clamping legs extend downward from the main body portion to clamp a left side and a right side of a solder ball, and the main body portion and the clamping legs are located on a same plane; each of the accommodating slots has a front wall, a connecting block protrudes backward from the front wall, a first position limiting block is formed by extending downward from the connecting block, the first position limiting block has a top surface, the connecting block has a bottom surface and an oblique surface extending obliquely upward from the bottom surface such that a width of the connecting block gradually become shorter upward from bottom thereof, the bottom surface is connected to the top surface, and the top surface protrudes out of the bottom surface leftward, rightward and forward respectively; a second position limiting block protrudes downward from the lower surface behind each of the solder ball, and the solder ball is limited by the first position limiting block and the second position limiting block from moving in the front-rear direction.

13. The electrical connector according to claim 12, wherein the accommodating slots in two adjacent rows in a front-rear direction are staggered, a third position limiting block protrudes from the lower surface behind the clamping legs and a fourth position limiting block protrudes from the lower surface in front of the clamping legs, the third position limiting block is connected to the first position limiting block, and the fourth position limiting block is connected to the stopping block and the second position limiting block.
